(19) United States
(12) Patent Application Publication
(10) Pub. No.: US 2002/0006181 A1
(43) Pub. Date: Jan. 17, 2002

(54) Method and device for estimating bone mineral content of the calcaneus

(76) Inventors: Innes K. MacKenzie, Guelph (CA); William Tait, Waterloo (CA); Jian-Xiong Wang, Guelph (CA)

Correspondence Address: DOWELL & DOWELL PC, SUITE 309, 1215 JEFFERSON DAVIS HIGHWAY, ARLINGTON, VA, 22202

(21) Appl. No.: 09/891,219

(22) Filed: Jun. 26, 2001

Related U.S. Application Data
(63) Continuation-in-part of application No. 09/235,236, filed on Jan. 22, 1999, now Pat. No. 6,252,928.
(60) Provisional application No. 60/072,312, filed on Jan. 23, 1998.

(51) Int. Cl. G01B 15/02; G01N 23/06

(52) U.S. Cl. 378/54; 378/53; 378/89

(57) ABSTRACT

The present invention provides an in situ, low dose and noninvasive method and device for estimating bone mineral content of trabecular bones, particularly the calcaneus. The method of estimating bone mineral content involves measuring the intensity of X-rays backscattered from the calcaneus and estimating the calcium content from this intensity. In one embodiment the X-ray source is a small x-ray tube that provides a continuous energy spectrum of X-rays. The intensity of backscattered X-rays from the soft tissue covering the trabecular bone, preferably the calcaneus, is compensated for by directly measuring the thickness of the soft tissue. Alternatively the soft tissue thickness can be measured directly along with the bone mineral content from the backscattered X-rays by measuring intensity over an energy range and correlating these results with a model of backscattering from a trabecular bone covered with a layer of soft tissue.

### CROSS REFERENCE TO RELATED U.S. PATENT APPLICATIONS

This patent application is a continuation-in-part application of U.S. patent application Ser. No. 09/235,236 filed on Jan. 22, 1999 entitled METHOD AND DEVICE FOR ESTIMATING BONE MINERAL CONTENT OF THE CALCANEUS, now allowed, which relates to United States provisional patent application Ser. No. 60/072,312 filed on Jan. 23, 1998 entitled METHOD AND DEVICE FOR ESTIMATING BONE MINERAL CONTENT OF THE CALCANEUS.

### FIELD OF THE INVENTION

The present invention relates in general to a low dose, in situ and noninvasive method and device for estimating human bone mineral content and more particularly the present invention relates to a method for monitoring osteoporosis by analyzing X-ray backscatter to estimate the calcium content of the calcaneus, specifically an average volumetric bone mineral density.

### BACKGROUND OF THE INVENTION

Osteoporosis is a condition of the human skeleton that is characterized by deleterious loss, over time, of bone mineral content, particularly calcium. The disease, while most prevalent in women past menopause, is commonly considered an aging disease present in both men and women. Individuals exhibiting osteoporosis are very prone to fractures, most commonly in the wrist, spine and hips. Death rates among men and women due to complications associated with osteoporosis are quite significant, numbering in the tens of thousands a year in North America. Experience has revealed no single measure of bone quality or quantity that is a reliable indicator of fracture risk. For example, microcracks from prior stresses increase risk but are not “visible” in most measurements. Nevertheless, it is widely accepted that the strength of bone (i.e., its resistance to fracture) is roughly proportional to the mass density of the bone mineral and this, in turn, is proportional to the calcium concentration.

New treatments and therapies have recently been, and are currently being, developed to treat osteoporosis. Two basic approaches to treatment are taken; one relates to intervening in order to reduce the amount of bone loss which accompanies aging, and the other involves replacing lost calcium or increasing calcium content. Early detection of bone mineral loss would be very advantageous, particularly if steps can be taken in the very early stages to slow down calcium depletion. The ability to measure, noninvasively and in situ, bone mineral content is crucial to early detection of osteoporosis and other related skeletal degenerative diseases.

There are several techniques available for measurement of bone mineral content. Computed tomography (CT) involves measurement of X-rays transmitted through the different parts of the anatomy detected by arrays of detectors whereupon cross-sectional images are constructed of internal structures of the body from transmitted X-ray data from which mineral loss data is obtained. Dual energy X-ray absorptometry (DXA) uses a dual energy approach in order to correct for tissue variations and to permit quantification of bone mass.

More specifically, U.S. Pat. No. 5,535,750 issued to Matsui et al. is directed to a method and device for monitoring development of osteoporosis using ultrasonic monitoring of a heel or a knee bone. The method involves measurement of velocity differences of acoustic signals transmitted through the subject bones.

U.S. Pat. No. 5,483,965 issued to Weiner et al. teaches insertion of the heel of a person into a water bath in an apparatus containing ultrasonic transducers to perform densitometry. Acoustic signals are transmitted through the user's foot and a receiver on the other side of the foot detects the signals and measures the transit time and attenuation of a selected frequency thereby obtaining a profile of the bone content.

U.S. Pat. No. 5,335,260 issued to Arnold is directed to a method of quantifying calcium, bone mass and bone mass density via X-ray radiography that involves use of a calibration phantom comprising a material to simulate human tissue. X-rays of sufficient energy and intensity are transmitted through the limb and a detector on the other side of the limb processes the transmitted X-ray data.

U.S. Pat. No. 5,204,888 issued to Tamegai et al. discloses a method for measurement of bone mineral content through irradiating an object with X-rays and measuring the transmitted X-ray intensity. The device uses an X-ray generator that produces X-rays over a continuous spectrum and a detector placed on the other side of the object being provided to measure transmitted X-ray intensities.

U.S. Pat. Nos. 4,510,450 and 4,635,643, both issued to Brown teach use of nuclear magnetic resonance for determining mineral content of bone. U.S. Pat. No. 4,510,450 claims a rotor device which acts as a holder for the assay during the test and U.S. Pat. No. 4,635,643 claims the actual method of probing for mineral content using ³¹P NMR.

U.S. Pat. No. 5,521,955 issued to Gohno et al. discloses an apparatus for bone density measurement and non-destructive inspection using a computed tomography (CT) scanner. The method requires scanning a calibration sample produced by mixing a water equivalent material (a material having the same X-ray transmission rate as that of water) with different ratios of a standard material equivalent to bone mineral mass (a material having the same X-ray transmission rate as that of bone mineral mass) and determining the bone density relative to the standard samples.

U.S. Pat. No. 4,829,549 issued to Vogel et al. is directed to a densitometer for predicting osteoporosis by measurement of bone mineral content by transmission of X-rays/gamma rays through the heel bone. A foot holder is provided with a radioactive source holder mounted in the foot holder along with a detector mounted in the foot holder opposite the source holder,

U.S. Pat. No. 5,351,689 issued to MacKenzie teaches a method and apparatus for low dose estimates of bone minerals using gamma ray backscattering. The method disclosed in this patent relies upon measuring the backscattering from bones and comparing the intensities in two areas of the backscatter spectrum. One area, A₁, derives most of its intensity from Rayleigh scattering while the other area, A₂, combines the events from both Rayleigh and Compton scattering. The shape parameter, W=A₁/A₂, is approximately a linear function of bone mineral content because most of the Rayleigh scattering is due to calcium content of the bone mineral.

A drawback to many of the above-mentioned devices and procedures for measuring bone content is the need for very expensive, large and heavy equipment and in some cases high radiation doses. Such systems, for example the whole body or axial DXA and CT systems require a dedicated centralized location and require attendance by specialized technicians to oversee the scanning process. This results in availability being restricted to medical facilities that are financially well supported. Furthermore, DXA systems, which have the highest market penetration, provide an areal bone density measurement in units of grams per square centimeter because of the transmission nature of the technique. Ideally a volumetric measurement is required so that artifacts are not introduced due for example to differences in bone thickness or orientation.

Therefore, it would be very advantageous to provide an in vivo, low dose, rapid and inexpensive method and device for monitoring volumetric bone mineral content that is portable and does not require sophisticated analysis techniques for interpreting the results. Such a device would readily lend itself to large scale use and may be used by any age group for monitoring bone development and would be very useful as a first tool in a program for early detection and prevention of osteoporosis as well as for monitoring the effectiveness of any dietary or pharmaceutical therapeutic program in respect of impact on bone mineral content.

### SUMMARY OF THE INVENTION

It is an object of the present invention to provide a method and apparatus for estimating bone mineral content of certain bones, with a high trabecular bone content.

It is also an object of the present invention to provide a method for monitoring osteoporosis using the measured X-ray radiation backscattered from the calcaneus.

The present invention provides a non-destructive, low dose, in-situ method of estimating bone mineral content by measuring the intensity of X-rays backscattered from certain trabecular bones.

In one aspect of the present invention there is provided a low dose in vivo method for estimating bone mineral content of certain trabecular bones. The method comprises the steps of:

a) immobilizing a person's anatomical part containing trabecular bone;

b) providing a source of X-rays wherein at least some of said X-rays emitted therefrom have an energy in a range so that absorption of said X-rays by calcium competes with scattering of said X-rays by calcium and other constituents making up trabecular bone;

c) irradiating a target trabecular bone in an anatomical part with a low radiation dose from said X-ray source;

d) measuring an intensity spectrum of backscattered X-ray radiation from a person's anatomical part;

e) providing a theoretical model having model parameters for backscattering of X-rays from said target trabecular bone which accounts for a thickness of soft tissue between said target trabecular bone and said source of X-rays; and

f) determining a thickness of soft tissue between said target trabecular bone and said source of X-rays and using said theoretical model and said thickness of soft tissue to calculate a bone mineral concentration in said target trabecular bone from the intensity spectrum of backscattered X-ray radiation.

In this aspect of the invention the step of irradiating a target trabecular bone may include irradiating the target trabecular bone with X-ray radiation from an X-ray tube.

In another aspect of the invention there is provided an apparatus for low dose in vivo measurement of bone mineral content of trabecular bones, comprising:

a support frame for holding a person's anatomical part containing a trabecular bone;

an X-ray source mounted on said support frame for providing a continuous energy spectrum of X-rays:

a detection means mounted on said support frame for detecting an energy spectrum Iₙ (Eₙ) of X-rays backscattered from said trabecular bone, wherein Iₙ is the intensity at energy value Eₙ and n is an integer with a range of values such that Eₙ spans a preselected range of energies being detected by said detection means, said X-ray source and said detection means being positioned with respect to each other so that a beam of X-rays produced by said X-ray source is directed away from said detector into a person's immobilized anatomical part, wherein at least some of said X-rays in said beam have an energy in a range so that absorption of the X-rays by calcium competes with scattering of said X-rays by calcium and other constituents making up a trabecular bone; and

computer control and processing means connected to said detection means for receiving data from said detection means and calculating a bone mineral concentration in the trabecular bone from said energy spectrum of the backscattered X-rays.

In another aspect of the invention there is provided an apparatus for in vivo measurement of bone mineral content of trabecular bones, comprising:

a support frame for holding and immobilizing a person's anatomical part containing a trabecular bone to said support frame;

a detector mounted on said support frame for detecting an intensity of X-rays;

an X-ray source positioned with respect to said detector so that a beam of X-rays is directed away from said detector into a person's immobilized anatomical part, the detector being positioned with respect to said X-ray source to measure an intensity of X-rays backscattered from said trabecular bone, wherein at least some of said X-rays in said beam have an energy in a range so that absorption of the X-rays by calcium competes with scattering of said X-rays by calcium and other constituents making up a trabecular bone;

thickness measurement means for measuring a thickness of soft tissue covering said trabecular bone; and

a processor for calculating a bone mineral concentration in the trabecular bone from said intensity of backscattered X-rays.

In this aspect of the invention the thickness measurement means is an ultrasound source and detector mounted on said support frame, said ultrasound source and detector adapted to produce an ultrasound signal wherein said detector detects an ultrasound signal reflected from said trabecular bone, and wherein said soft tissue thickness is determined from a transit time for said ultrasound signal through said soft tissue and back from said trabecular bone.

### BRIEF DESCRIPTION OF THE DRAWINGS

The method and device for estimating calcium content of trabecular bones will now be described, by way of example only, reference being made to the following drawings:

FIG. 1 shows a vertical view of the device for estimating calcium in a person's calcaneus constructed in accordance with the present invention;

FIG. 2 is a view along line 28 of FIG. 1:

FIG. 3 shows a view of an alternative embodiment of a device for estimating calcium in a person's calcaneus constructed in accordance with the present invention;

FIG. 3a is a detailed blow-up view of the device of FIG. 3;

FIG. 4 is a view from the left of FIG. 3;

FIG. 5 is block diagram of the apparatus of FIGS. 3 and 4;

FIG. 6 is a one-dimensional model of the heel showing soft tissue covering a semi-infinite slab of bone, suitable for mathematical analysis;

FIG. 7a shows a top view of an ultrasonic source/detector pressed up against a user's foot for measuring the thickness of the soft tissue between the skin and bone;

FIG. 7b shows a blow-up of the ultrasound waveform shown in FIG. 7a; and

FIG. 8 shows an intensity spectra of backscattered radiation for two different bone mineral densities.

### DETAILED DESCRIPTION OF THE INVENTION

The present invention provides a method and device for an in situ, low dose estimation of bone mineral content of certain trabecular bones by measuring the intensity of X-rays backscattered from the trabecular bone. Periodic measurements of the person using the present method and device permits one to monitor changes in bone density as the person ages.

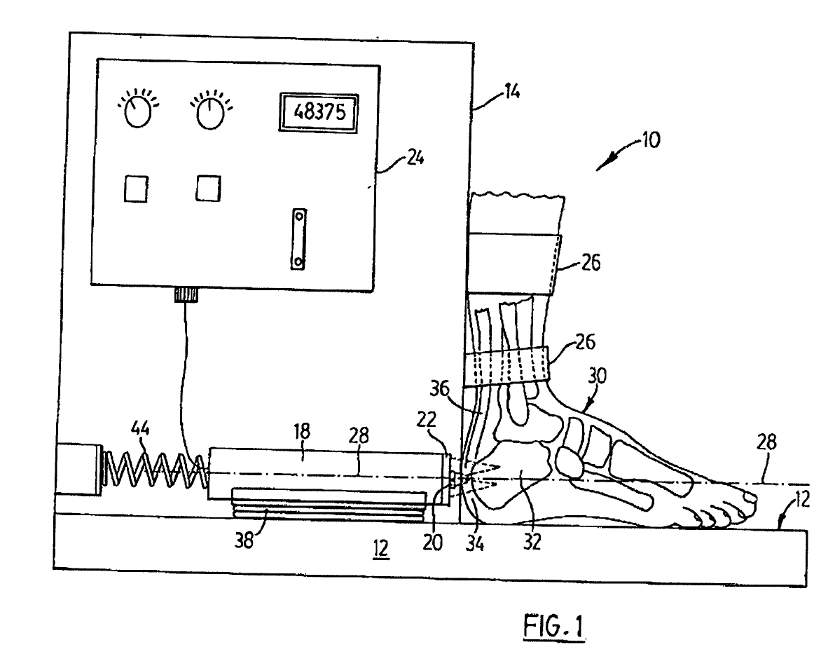

Referring to FIG. 1 an apparatus for estimating calcium content of trabecular bones such as the calcaneus (heel bone) is shown generally at 10. Apparatus 10 includes a platform 12 which provides a foot and leg support for a user's foot 30. A housing 14 encloses a radioactive source/detector assembly 18 mounted therein. The source/detector assembly 18 comprises an axially symmetric heavy-metal radioactive source holder (collimator) 20 containing a radioactive source mounted on the cylindrical axis 28 of a cylindrically symmetric radiation detector 22, for example, a NaI(TI) scintillation counter and photomultiplier. Source/detector assembly 18 is connected to a control circuit 24 which while shown mounted in housing 14 may be located away from the housing. Control circuit 24 is connected to detector 22 and includes timing circuits and processors to process the data from the detector. Restraining straps 26 are used to hold the user's foot 30 immobile on apparatus 10.

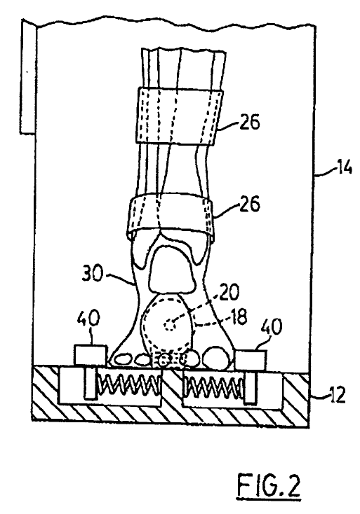

Measuring the calcium concentration of the calcaneus is preferred for reasons to be discussed hereinafter. The source holder/detector assembly 18 is mounted in housing 14 so that when a user's foot 30 is immobilized on apparatus 10 the source-holder 20, which is spring-loaded using a spring 44 to compress the soft tissue in region 34, is held firmly against the centre of the rear of the patient's heel so the X-rays penetrate through the soft tissue 36. An alignment mechanism 38 allows assembly 18 to be raised and lowered and moved side-to-side and oriented in the vertical plane to allow adjustment to differently sized feet. Referring to FIG. 2, two alignment beams 40 are disposed on each side of the person's foot on platform 12 and spring biased inwardly so that when a user places his or her foot on the platform it is held in alignment by beams 40.

The apparatus exploits the cylindrical symmetry of the source containing collimator 20 and detector 22 and uses shadowing or geometric hindrance by the heavy-metal collimator to prevent both primary X-rays from the source and X-rays backscattered from the soft tissue under the skin covering the calcaneus in region 34 (FIG. 1) from reaching detector 22. The shape of the source holder 20 can be designed to give the desired amount of collimation of the X-ray beam. The beam of X-rays emanating from collimator 20 is backscattered from the constituents making up the calcaneus, as can be seen from the broken ray lines in FIG. 1. The backscattered X-rays can be counted very efficiently by detector 22, provided that these X-rays reach the detector without being absorbed.

The radioactive source may be ¹⁰⁹Cd that emits the K X-rays of silver (22 to 25 Kev) but other suitable radioactive sources or an X-ray tube may be used. The collimator 20 directs the cone of primary X-rays along the axis 28 of the detector 22 but in the opposite direction away from the detector. The method relies upon measuring the intensity of X-rays backscattered from the various components making up the calcaneus (heel bone) 32 and relating this intensity to the concentration of calcium present. All of the tissues of the human body are very weak absorbers of 20 keV X-rays with the sole exception of bone. Even the bone is a weak absorber except for that part of the bone that is in the form of a mineral called apatite. Apatite comprises mainly calcium phosphate of which calcium is the main X-ray absorber and therefore to a good approximation the observed counting rate provides a measure of the calcium content of the heel; the more calcium, the lower the counting rate and this inverse relationship has been observed to be smoothly varying such that for a given soft tissue thickness there is a unique inverse relationship between counting rate and calcium concentration. Such relationships have been determined using phantoms to represent the calcaneus and its covering of soft tissue.

X-rays are backscattered primarily via Compton scattering (although Rayleigh scattering also contributes to scattering) and are detected by the scintillation detector. The end portion of the detector/source assembly 18 containing the collimator 20 is held firmly against an anatomically determined position on the person's heel so that the X-rays penetrate through the compressed soft tissue 36 in region 34 (FIG. 1) and in a direction more or less parallel to the sole of the foot 30. This means that the X-rays are transmitted into the calcaneus after penetration of typically 8 mm of soft tissue 36 that covers the calcaneus in region 34. Most of the transmitted X-rays will collide with electrons in the chemical constituents of the calcaneus in the process of Compton scattering. In this process, the X-rays lose some of their energy, the loss depending on the angle at which they are scattered Those X-rays from an X-ray tube that are scattered back toward the detector 22 have a distribution of energies centred approximately around 22 keV.

For purposes of monitoring osteoporosis in humans, the calcaneus is the preferred bone to monitor because it has the highest percentage of spongy or trabecular bone in the human body which because of its high surface area is prone to mineral loss due to osteoporosis. Also clinical studies have shown a good correlation between bone mineral density of the calcaneus and the risk of fracture of other bones in the human body. In addition to the mineral constituent of calcium phosphate, the calcaneus also comprises collagen, a biological polymer, and bone marrow, which is primarily fat. Both collagen and bone marrow are normally classified as soft tissue.

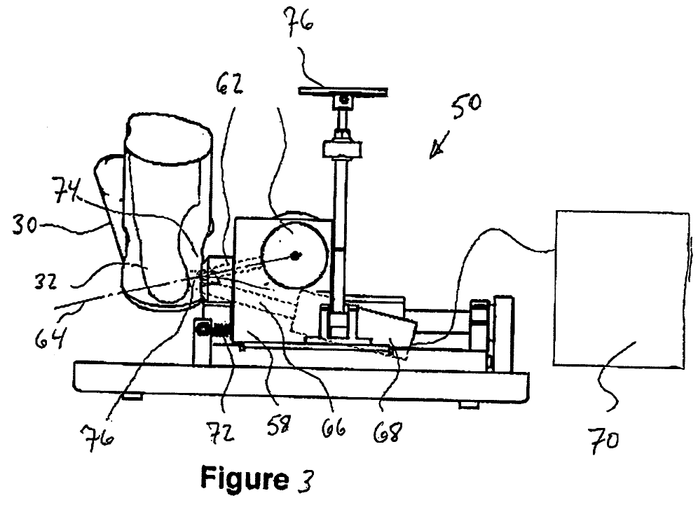

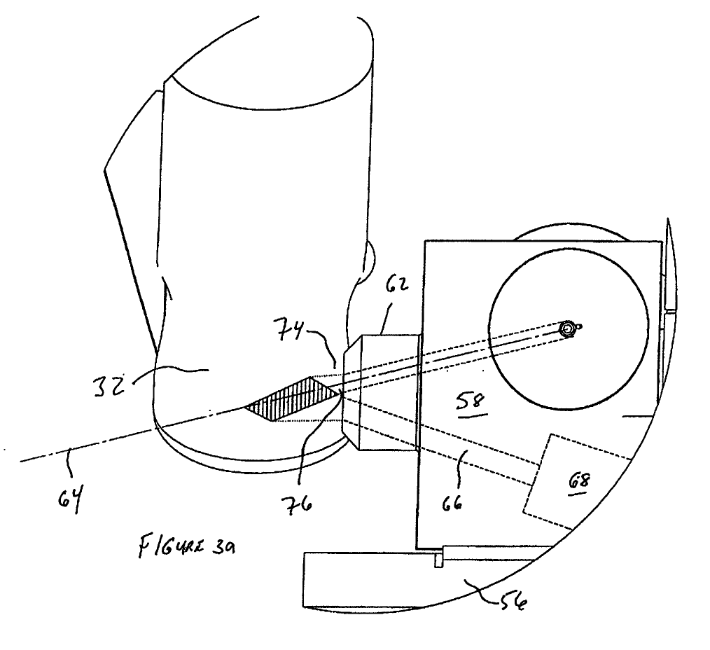

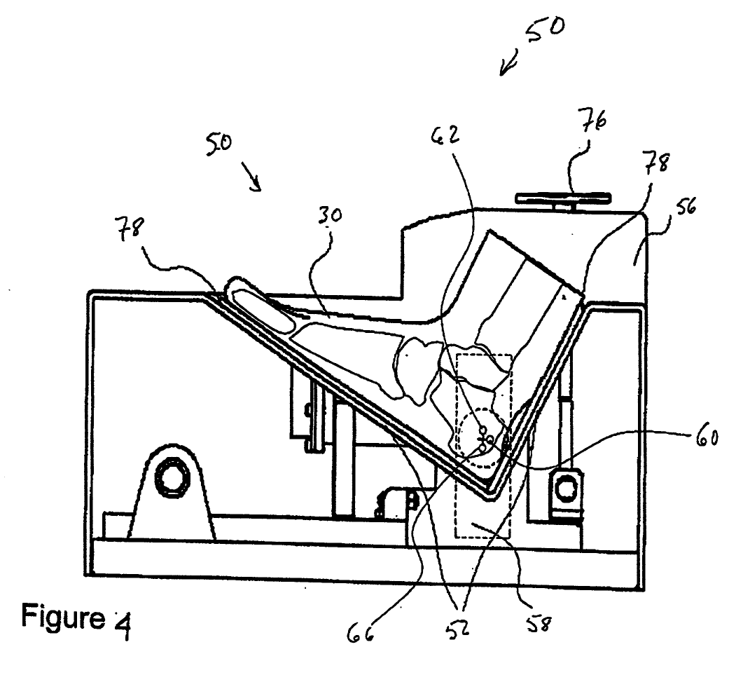

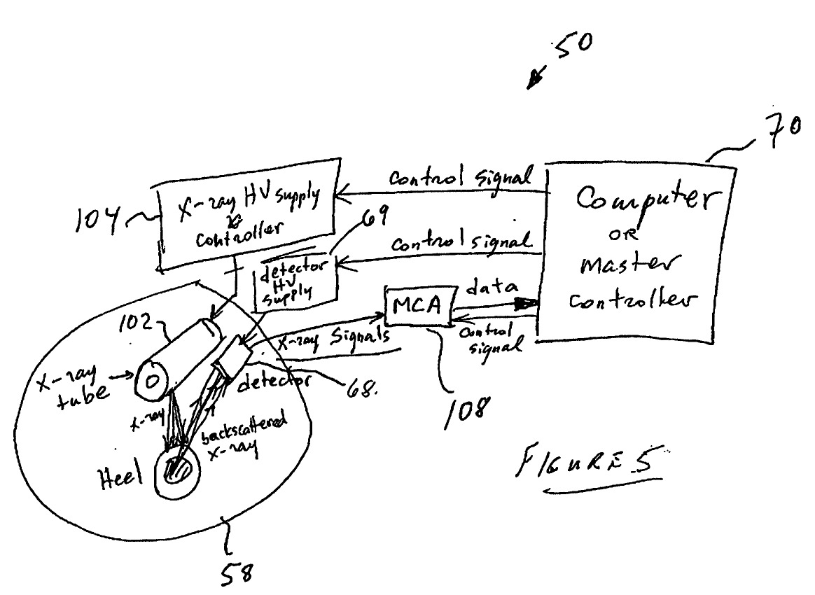

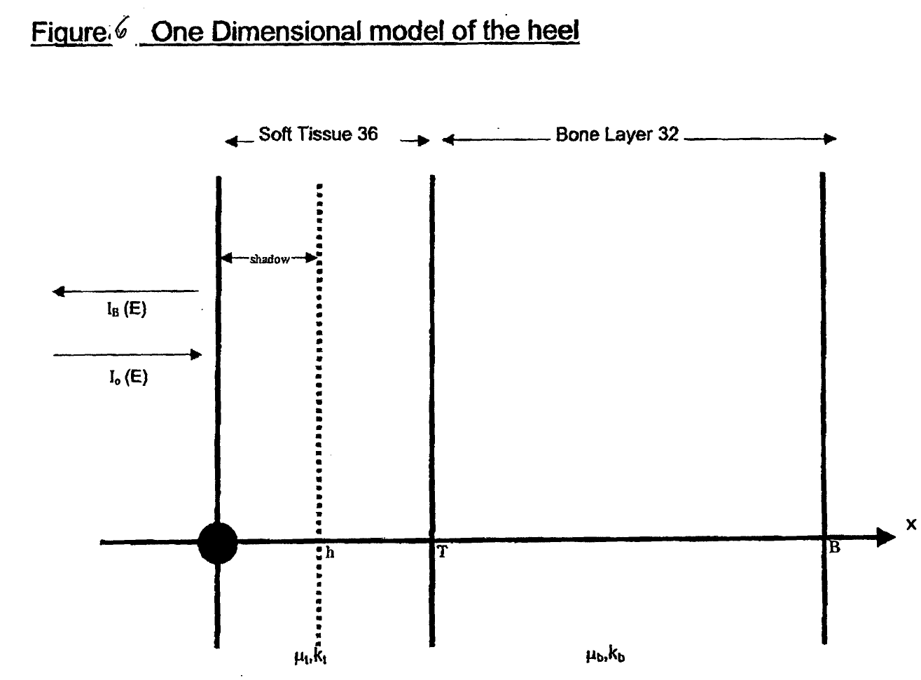

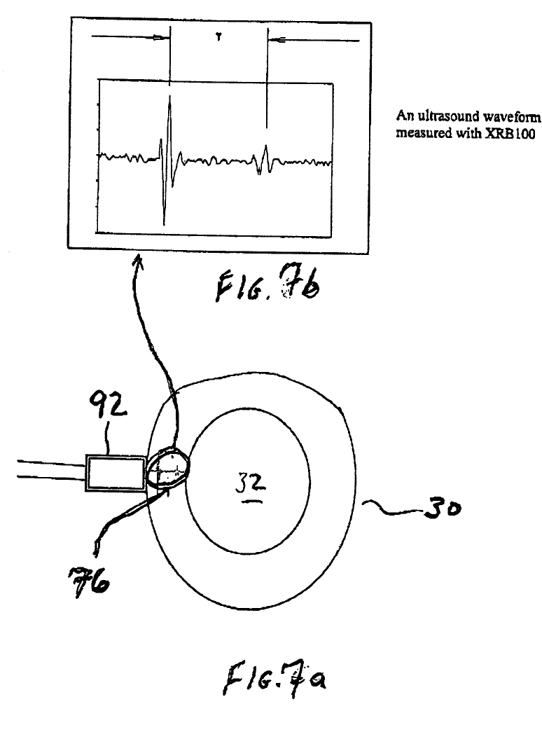

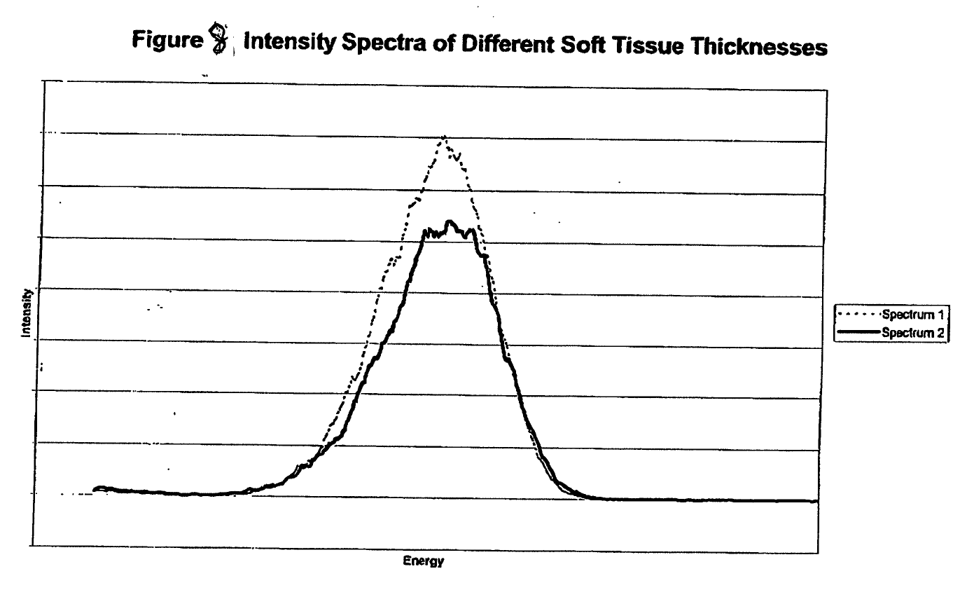

Referring to FIGS. 3, 3a and 4 an alternative embodiment of an apparatus for estimating calcium content of trabecular bones is shown generally at 50. Apparatus 50 includes a foot-well 52 (FIG. 4) which provides a foot and leg support for a users foot 54. A housing 56 (FIG. 4) encloses an X-ray source/detector assembly 58 mounted therein. The source/detector assembly 58 provides an x-ray beam from source 60 through collimator 62 with cylindrical axis 64 and detection aperture 66 for a cylindrically symmetric radiation detector 68, for example, a NaI(TI) scintillation counter and photomultiplier. Source/detector assembly 58 is connected to a control circuit 70 that while shown mounted outside housing 14 may be mounted inside housing 56. A computer control and processor 70 is connected to detector 68 and x-ray source 60 and includes timing and control circuits and processors to process the data from the detector 68. Restraining means (not shown) may be used to hold the user's foot 30 immobile on apparatus 50.

The x-ray source/detector assembly 58 is mounted in housing 56 (FIG. 4) so that when a user's foot 30 is placed in apparatus 50 the source/detector assembly 58, which is spring-loaded using a spring 72 to compress the soft tissue in region 74 (FIG. 3), is placed against the patient's heel so that the X-rays penetrate through the soft tissue 76 (FIG. 3). A mechanism 76 allows assembly 58 to be raised and lowered and shims 78 (FIG. 4) are provided to permit adjustment for differently sized feet.

The geometry of the collimator 62 and detection aperture 66 determines the degree of shadowing or geometric hindrance to prevent primary X-rays from the source and X-rays backscattered from the soft tissue 76 under the skin covering the calcaneus in region 74 (FIG. 3) from reaching detector 68. The shape of the collimator 62 can be designed to give the desired amount of collimation of the X-ray beam. The beam of X-rays emanating from collimator 62 is backscattered from the soft tissue and the calcaneus within region 74. The backscattered X-rays can be counted very efficiently by detector 68, provided that these X-rays reach the detector without being absorbed.

Referring to block diagram of apparatus 50 shown in FIG. 5, the preferred X-ray source is a small X-ray tube 102, for example model series SXR-80 provided by Superior X-ray Tube Company. The X-ray tube 102 is driven by a high voltage source 104 at 35-40 kV and provides a continuous energy spectrum of X-rays. Detector 68 includes a power supply 69 and detector 68 is connected to a multi-channel analyzer 108, which is connected to the computer controller and processor 70. Controller 70 receives the data from the detector and multi-channel analyzer and processes the data. Control signals from controller 70 to the power supply 104, multi-channel analyzer 108 and detector power supply 69 controls the apparatus in operation.

Other suitable sources of X-rays when total backscattered intensity is measured, rather than an intensity spectrum, are radioactive sources such as ¹⁰⁹Cd that emits the K X-rays of silver in the energy range from 22 to 25 keV. The collimator 62 directs the cone of primary X-rays along the axis 64 in a direction away from the detector. The method relies upon measuring the intensity of X-rays backscattered from the various components making up the calcaneus (heel bone) 32 and covering soft tissue 76 and relating this intensity to the concentration of calcium present. The specific arrangement of the source-holder bearing against the side of the heel at region 74 is highly preferred because it exploits the size and shape of the calcaneus when accessed by X-rays in the above-noted direction. This location is also preferred due to a small amount of soft tissue between the calcaneus and the portion of the skin on the heel against which the source/detector assembly 58 (FIG. 3) is engaged.

Devices 10 (FIG. 1) and 50 (FIG. 3 and 4) may include a positioning device with the X-ray source and detector assembly being mounted on the positioning device for adjusting the position of the assembly in an arcuate path with respect to the person's foot. The positioning device includes a locking mechanism for locking assembly 58 in a selected position with respect to the person's foot, for example at the back or at the side of the foot depending on where the measurements are to be made.

For monitoring the calcium content of the heel bone there is required an X-ray energy that is capable of penetrating about 1.5 cm into a healthy calcaneus. This will ensure a much deeper penetration into an osteoporotic calcaneus because of the relative lack of calcium and hence decreased photoelectric absorption. The X-ray energy must be low enough to ensure a strong contrast in the absorption of both the primary and scattered X-rays because of the presence of calcium. An X-ray tube providing X-rays in the range of 10 to 40 keV is preferred and a ¹⁰⁹Cd source is also useful since it emits X-rays in the energy range 22 to 25 keV.

Similar to device 10 In FIGS. 1 and 2, the end portion of the detector/source assembly 58 in device 50 in FIGS. 3 and 4 containing the collimator 62 is held firmly against an anatomically determined position on the person's heel so that the X-rays penetrate through the compressed soft tissue 76 in region 74 (FIG. 3) and in a direction more or less parallel to the sole of the foot 30. This means that the X-rays are transmitted into the calcaneus after penetration of typically 8 mm of soft tissue 76 that covers the calcaneus in region 34. Most of the transmitted X-rays will collide with electrons in the chemical constituents of the calcaneus in the process of Compton scattering. In this process, the X-rays lose some of their energy, the loss depending on the angle at which they are scattered. Those X-rays from an X-ray tube that are scattered back toward the detector 22 have a distribution of energies centred approximately around 22 keV.

As mentioned above, it is predominantly Compton scattering that causes scattered X-rays to be directed back to the detector 22 in device 10 of FIG. 1 and detector 68 in device 50 of FIG. 3. The greater the density of the material, the more Compton scattering occurs and so normally it would be anticipated that an increase of bone mineral density would lead to an increase in backscatter intensity. However, the opposite occurs in the present invention because the energy of the X-rays has been chosen such that it is primarily the chance of absorption by calcium (rather than the chance of scattering) that determines the backscattered X-ray intensity.

It is noted that the contrast is not due to the difference of absorption and scattering by the calcium alone. Even in a non-osteoporotic calcaneus, most of the scattering is done by the other components making up the calcaneus rather than the calcium. So the objective is to achieve a situation in which absorption by calcium competes on more or less equal terms with scattering by the combination of these other components and calcium. Therefore, by making periodic measurements of the calcium content of the person's calcaneus the present invention can be used to monitor the development of osteoporosis based on changes in the measured X-ray radiation backscattered from the calcaneus resulting from varying concentrations of calcium phosphate over time.

In the X-ray measurement, the main effect is that the volume of the target that is “sampled” by the X-rays is determined by the total absorption if the target has a lower absorption (such as an osteoporotic heel) the counts are received from a larger volume of the calcaneus. As calcium content increases (progressively more healthy calcanei) the sample volume keeps its general shape but the volume decreases because backscattered photons are absorbed before they can reach the detector.

More specifically, with respect to shadowing, the collimator/aperture geometry is designed to provide sufficient shielding to prevent the primary photons from going directly to the detector in numbers that would mask the signals originating from the backscatter in the target. The geometry is also designed to reduce backscatter from soft tissue close to the detection aperture since this backscatter signal contains no information pertaining to bone mineral density and its effect is to reduce the sensitivity of the backscatter to bone mineral or calcium concentration. Since the thickness of soft tissue covering the calcaneus varies from person to person and tends to be thicker for larger heavier people the method and apparatus pertaining to the current invention recognizes the differences in people's soft tissue thickness and allows for soft tissue thickness explicitly in the estimation of calcium concentration or bone mineral density of the calcaneus.

Calibration of the backscatter count rate against calcium concentration and soft tissue thickness can be achieved using suitable calibration phantoms. These comprise, for example, finely powdered calcium phosphate (CaHPO₄) evenly dispersed in petroleum jelly contained in Nalgene bottles to represent the heel bone and water bags of different thicknesses to represent the soft tissue. The functional form of this calibration and its dependence on key parameters such as dimensions and materials composition can be understood in terms of the following mathematical model the application of which to estimate bone mineral density being part of the present invention.

For a one dimensional model the detected backscattered radiation is directed at 180° to the incident x-ray beam from the collimator, and it is assumed that the Compton backscattered radiation has the same energy as the incident beam and that no distinction is made between the Rayleigh and Compton backscattered components. FIG. 6 shows a one-dimensional representation of the heel anatomy with incident radiation intensity spectrum I_{O} (E) directed at a layer of soft tissue 76 (FIG. 3) of thickness T over a bone layer 32, thickness B which is large compared to T and a geometric shadow or dead zone with thickness h. The parameters μₜ, kₜ and μ_{b}, k_{b} are the absorption and backscattering coefficients respectively for the soft tissue and bone layers and

μ_{b}=μₘα+μₛ(1−α)

k_{b}=kₘα+kₛ(1−α)

where the subscripts m and s refer to the mineral and soft tissue (e.g. marrow) content of the calcaneus and α is the fraction by volume of the bone comprising bone minerals. A straightforward physical argument leads to the formula for the backscattered intensity I_{B}(E)

$$\text{Equation 1:}$$

$$\frac{{I}_{B} ( E )}{{I}_{O} ( E )} = \frac{{k}_{t}}{2 {μ}_{t}} ( {ⅇ}^{- 2 {μ}_{i} h} - {ⅇ}^{- 2 {μ}_{i} T} ) + \frac{{\dot{k}}_{b}}{2 {μ}_{b}} {ⅇ}^{- 2 {μ}_{i} T}$$

This formula provides a functional relationship exhibiting the dependence of the backscattered intensity on the volumetric bone mineral concentration as represented by α and the soft tissue thickness T. Also involved is the shadow depth h which is a property of the apparatus and can be measured. The absorption and scattering parameters of the anatomical constituents can be estimated from their atomic composition, and may be simulated by the construction of phantoms as indicated above.

The soft tissue thickness T in region 36 at the back of the heel in FIG. 1 or region 76 at the side of the heel in FIG. 3 may be measured directly, using an ultrasound transducer 60 as shown in FIG. 4 situated near the collimator 62 and detector aperture 66 on the source/detector assembly 58. Referring to FIGS. 7a and 7b, an ultrasound pulse emitted by the transducer 92 in intimate contact with the soft tissue in region 76 of the foot 30 is reflected from the calcaneus 32 and detected by the transducer 92. Ultrasound is a quick and reliable mean for thickness gauging and typical operational frequencies are between 500 KHz and 100 MHZ, using piezoelectric transducers to generate bursts of sound waves when excited by electrical pulses. The present X-ray bone mineral densitometer device 60 uses 2.25 MHz and 5.0 MHz frequencies for optimizing both penetration and precision requirement in the highly attenuating and scattering soft tissue material.

The soft tissue thickness is then estimated by measuring the time required for a short ultrasonic pulse generated by a transducer to travel through the thickness of the soft tissue, reflect from the heel bone surface, and be returned to the transducer. The measured two-way transit time is divided by two to account for the down-and-back travel path, and then multiplied by the velocity of sound in the test material, The result is expressed in the well-known relationship: D=V*T/2 where D=the thickness of the soft tissue, V=the velocity of sound waves in the soft tissue, T=the measured round-trip transit time. The speed of sound in soft tissue is 1.54 mm/μs. For most adults, soft tissue thickness at the heel side is between 5 mm to 13 mm with an average of about 9 mm. The down-and-back travel time is about 6 to 16 μs.

The above equation (Equation 1) may be used to estimate calcium concentration or bone mineral density from the ratio of backscattered radiation I_{B} to the incident intensity I_{O}. The first term represents backscatter from the soft tissue layer, while the second term represents backscatter from the bone layer assuming that thickness B is relatively large. Clearly by inserting numerical values for the intensities, the absorption and scattering constants and soft tissue thickness T, this equation can be solved for α, the average fractional concentration by volume of bone mineral in bone.

The one dimensional model as depicted in FIG. 6 with the model Equation 1 are approximations herein included to illustrate the method. Those skilled in the art will readily appreciate that this model may be extended to include the effects of the backscatter angle being less that 180°; the solid geometry of the collimator and detection aperture; the separation of the Compton and Rayleigh scattering contributions; and the energy dependence of the absorption and backscatter coefficients in the Compton scattering contribution.

Another embodiment of the present invention avoids the use of an ultrasound-based measurement of the soft tissue thickness T, and instead estimates bone mineral density directly from the backscattered radiation intensity energy spectrum, examples of which are shown in FIG. 8. The energy spectrum is denoted by the vector Iₙ(Eₙ) wherein Iₙ is the intensity at energy value Eₙ and n is an integer with a range of values such that Eₙ spans the range of energies being detected. A preferred energy range is from about 10 to 30 keV. The method for estimating bone mineral density from the backscattered intensity vector Iₙ (Eₙ) follows the following steps:

1. Use the theoretical model described above to calculate Iₙ (Eₙ) for a range of values of bone mineral concentration α, and soft tissue thickness T.

2. Perform measurements of I_{O} (E_{O}) using phantoms with a similar range of values of α, and T.

3. Modify model parameters so that the results of the first two steps are numerically similar.

4. Invert the results of Step 3 with simple numerical formulae which express α, and T as functions of the intensity vector Iₙ (Eₙ), i.e.

α=f₁(Iₙ(Eₙ))

T=f₂(Iₙ(Eₙ))

5. Refine this functional description by parameterizing the vector Iₙ (Eₙ) using two parameters CR, the total count rate and SF, the shape factor such that:

α=f₃(CR, SF)

T=f₄(CR, SF)

where

$$CR = {\sum }_{a ‖ n} {I}_{n} ( {E}_{n} )$$

and SF is a vector formed from the normalized vector:

$${I}_{n} ( {E}_{n} ) ie . SF = \frac{1}{CR} {I}_{η} ( {E}_{n} )$$

which for ease of computation may be further parameterized for example, as

$$SF = \frac{1}{CR} {\sum }_{k = 1}^{N} {I}_{k} ( N - k + 1 )$$

where N is a suitably chosen cutoff value.

It will be understood that the parameterized equation for SF above is only one example or way of representation the shape factor SF and those skilled in the art will appreciate that there are numerous parameterization equations that may be used.

In this embodiment, from a measurement of the backscattered intensity spectrum Iₙ (Eₙ) using for example a multi-channel analyser the two parameters CR and SF can easily be computed and an estimate of volumetric bone mineral concentration α, can be determined using the function f₃ defined above.

In view of the fact that the strength of a bone (i.e., its resistance to fracture) is proportional to the mass density of the bone mineral and this, in turn, is proportional to the calcium content, the method disclosed herein for measurement of the intensity and intensity spectrum of the backscattered X-rays is a good indicator of the weakness of the bone, with the weaker bones giving higher backscattered X-ray intensities for the same soft tissue thickness.

The present invention measures an X-ray backscattering intensity that decreases with the mean volumetric density of bone mineral and hence the results can be expressed in units of grams/cubic centimeter. In contrast the DXA method provides an areal mineral density in units of grams/square centimeter. This is performed by measuring via transmission the mineral content with a measured surface area of bone. Clearly the same volumetric density can lead to different areal densities with different bone thicknesses or orientations.

Therefore, while the present invention has been described and illustrated with respect to the preferred embodiments for estimating mineral content of trabecular bones, it will be appreciated that numerous variations of these embodiments may be made depending on the application without departing from the scope of the invention as described herein.

Therefore what is claimed is:

1. A low-dose in vivo method for measuring bone mineral concentration in trabecular bone, said bone mineral including calcium, the method comprising the steps of:
a) immobilizing a person's anatomical part containing trabecular bone:
b) providing a source of X-rays wherein at least some of said X-rays emitted therefrom have an energy in a range so that absorption of said X-rays by calcium competes with scattering of said X-rays by calcium and other constituents making up trabecular bone;
c) irradiating a target trabecular bone in an anatomical part with a low radiation dose from said X-ray source;
d) measuring an intensity spectrum of backscattered X-ray radiation from a person's anatomical part;
e) providing a theoretical model having model parameters for backscattering of X-rays from said target trabecular bone which accounts for a thickness of soft tissue between said target trabecular bone and said source of X-rays; and
f) determining a thickness of soft tissue between said target trabecular bone and said source of X-rays and using said theoretical model and said thickness of soft tissue to calculate a bone mineral concentration in said target trabecular bone from the intensity spectrum of backscattered X-ray radiation.

2. The method according to claim 1 wherein the step of irradiating a target trabecular bone includes irradiating said target trabecular bone with X-ray radiation from an X-ray tube operating at 35 to 40 kilovolts.

3. The method according to claim 1 wherein said theoretical model of step e) includes an approximate formula for an intensity I_{B}(E) of backscattered X-rays given by
$$\frac{{I}_{B} ( E )}{{I}_{O} ( E )} = \frac{{k}_{t}}{2 {μ}_{t}} ( {ⅇ}^{- 2 {μ}_{i} h} - {ⅇ}^{- 2 {μ}_{i} T} ) + \frac{{k}_{b}}{2 {μ}_{b}} {ⅇ}^{- 2 {μ}_{i} T}$$
wherein I_{O}(E) is an incident X-ray intensity spectrum directed at a layer of soft tissue of thickness T over the target trabecular bone of approximate thickness B which is much thicker than T, wherein model parameters μₜ, kₜ and μ_{b}, k_{b} are absorption and backscattering coefficients respectively for the soft tissue and target trabecular bone and
μ_{b}=μₘα+μₛ(1−α)
k_{b}=kₘα+kₛ(1−α)
where the subscripts m and s refer to mineral and soft tissue content of the calcaneus and α is a fraction by volume of the trabecular bone comprising the bone minerals, and wherein h is an instrumental geometric shadow depth determined from an instrument used to produce the incident intensity I_{O}(E) of X-rays and detect the intensity I_{B}(E) of backscattered X-rays.

4. The method according to claim 3 wherein the soft tissue covering the target trabecular bone is irradiated by an ultrasound signal and the ultrasound signal reflected from said target trabecular bone is detected, and wherein said soft tissue thickness T is determined from a time of flight of said ultrasound signal.

5. The method according to claim 4 wherein said target trabecular bone is a calcaneus, and wherein the steps of immobilizing a person's anatomical part and irradiating a target trabecular bone includes at least immobilizing a person's foot and directing the X-rays through the soft tissue at a side of the person's heel whereby the X-rays are directed towards the calcaneus in a direction substantially parallel to the sole of the person's foot.

6. The method according to claim 5 including repeating steps a) to f) of claim 1 periodically and monitoring any changes in X-ray backscatter spectrum from the calcaneus to determine if the concentration of calcium is changing over time.

7. The method according to claim 1 wherein said theoretical model of step e) includes an approximate formula for an intensity I_{B}(E) of backscattered X-rays given by
$$\frac{{I}_{B} ( E )}{{I}_{O} ( E )} = \frac{{k}_{t}}{2 {μ}_{t}} ( {ⅇ}^{- 2 {μ}_{i} h} - {ⅇ}^{- 2 {μ}_{i} T} ) + \frac{{k}_{b}}{2 {μ}_{b}} {ⅇ}^{- 2 {μ}_{i} T}$$
wherein I_{O}(E) is an incident X-ray intensity spectrum directed at a layer of soft tissue of thickness T over the target trabecular bone of approximate thickness B which is much thicker than T, wherein model parameters μₜ, kₜ and μ_{b}, k_{b} are absorption and backscattering coefficients respectively for the soft tissue and target trabecular bone and
μ_{b}=μₘα+μₛ(1−α)
k_{b}=kₘα+kₛ(1−α)
where the subscripts m and s refer to mineral and soft tissue content of the calcaneus and α is a fraction by volume of the trabecular bone comprising the bone minerals, and wherein h is an instrumental geometric shadow depth determined from an instrument used to produce the incident intensity I_{O}(E) of X-rays and detect the intensity I_{B}(E) of backscattered X-rays.

8. The method according to claim 7 wherein the step d) in claim 1 of measuring an intensity spectrum of backscattered X-ray radiation from a person's anatomical part includes measuring a backscattered X-ray energy spectrum Iₙ (Eₙ) wherein Iₙ is an intensity at energy value Eₙ and n is a preselected integer.

9. The method according to claim 8 wherein the step f) in claim 1 includes:
a) using the theoretical model to calculate Iₙ (Eₙ) for a range of values of bone mineral concentration α, and soft tissue thickness T;
b) performing measurements of Iₙ (Eₙ) using calibration phantoms with a similar range of values of α and T:
c) modifying said model parameters so that the results of steps a) and b) are numerically similar;
d) invert the results of step c) using numerical formulae
α=f₁(Iₙ(Eₙ))
T=f₂(Iₙ(Eₙ))
which express α and T as functions of the intensity vector Iₙ (Eₙ);
e) refining the formulae for α and T in step d) by parameterizing the vector Iₙ (Eₙ) using two parameters including total count rate (CR) and a selected shape factor SF such that
α=f₃(CR, SF)
T=f₄(CR, SF)
where
$$CR = {\sum }_{a ‖ n} {I}_{n} ( {E}_{n} )$$
and SF is a vector formed from the normalized vector:
$${I}_{n} ( {E}_{n} ) ie . SF = \frac{1}{CR} {I}_{η} ( {E}_{n} ) ; and$$
f) calculating CR and SF from the measured backscattered X-ray energy spectrum Iₙ (Eₙ) of the target trabecular and calculating α from said calculated values of CR and SF using the function f₃ defined in step e) and calculating T using the function f₄ defined in step e).

10. The method according to claim 9 wherein steps a), b) and c) are performed once for a particular target trabecular bone and the results stored on a computer control means connected to an apparatus used to produce said X-rays and detect the backscattered X-rays.

11. The method according to claim 8 wherein said target trabecular bone is a person's calcaneus.

12. The method according to claim 8 wherein said backscattered X-ray energy spectrum Iₙ (Eₙ) spans an energy range from about 10 to about 30 Kev.

13. An apparatus for in vivo measurement of bone mineral content of trabecular bones, comprising:
a support frame for holding a person's anatomical part containing a trabecular bone;
an X-ray source mounted on said support frame for providing a continuous energy spectrum of X-rays;
a detection means mounted on said support frame for detecting an energy spectrum Iₙ (Eₙ) of X-rays backscattered from said trabecular bone, wherein Iₙ is the intensity at energy value Eₙ and n is an integer with a range of values such that Eₙ spans a preselected range of energies being detected by said detection means, said X-ray source and said detection means being positioned with respect to each other so that a beam of X-rays produced by said X-ray source is directed away from said detector into a person's immobilized anatomical part, wherein at least some of said X-rays in said beam have an energy in a range so that absorption of the X-rays by calcium competes with scattering of said X-rays by calcium and other constituents making up a trabecular bone; and
computer control and processing means connected to said detection means for receiving data from said detection means and calculating a bone mineral concentration in the trabecular bone from said energy spectrum of the backscattered X-rays.

14. The apparatus according to claim 13 wherein said X-ray source includes an X-ray tube and a power supply connected to said X-ray tube.

15. The apparatus according to claim 13 wherein said detection means includes a multi-channel analyser.

16. The apparatus according to claim 15 wherein including computer control and processing means is connected to a power supply that powers said detection means, said computer control means being connected to the X-ray tube power supply for controlling operation of said X-ray source and said detection means wherein said X-ray source and said detection means are responsive to control signals from said computer control and processing means.

17. The apparatus according to claim 16 wherein said computer control and processing means is connected to said multi-channel analyser.

18. The apparatus according to claim 13 wherein said support frame includes at least a support for supporting a person's foot containing a calcaneus, the X-ray source being mounted on said frame so that when a person's foot is immobilized on said foot support the X-ray source is located with respect to a person's heel so that the X-rays are directed toward the calcaneus along an axis of a person's foot substantially parallel to the sole of the foot.

19. The apparatus according to claim 18 including positioning means mounted on said frame, said X-ray source and said detection means being mounted on said positioning means for moving said X-ray source and said detection means in an arcuate path relative to a person's foot, and including locking means for locking said X-ray source and said detection means In a selected position with respect to the person's foot.

20. The apparatus according to claim 19 wherein said selected position includes a position at the back of the person's foot so that the X-rays are directed to the back of the person's calcaneus, and a position at the side of the person's foot so that the X-rays are directed to the side of the person's calcaneus.

21. The apparatus according to claim 13 wherein said preselected range of energies is about 10 to about 30 keV.

22. An apparatus for in vivo measurement of bone mineral content of trabecular bones, comprising:
a support frame for holding and immobilizing a person's anatomical part containing a trabecular bone to said support frame;
a detector mounted on said support frame for detecting an intensity of X-rays;
an X-ray source positioned with respect to said detector so that a beam of X-rays is directed away from said detector into a person's immobilized anatomical part, the detector being positioned with respect to said X-ray source to measure an intensity of X-rays backscattered from said trabecular bone, wherein at least some of said X-rays in said beam have an energy in a range so that absorption of the X-rays by calcium competes with scattering of said X-rays by calcium and other constituents making up a trabecular bone;
thickness measurement means for measuring a thickness of soft tissue covering said trabecular bone; and
a processor for calculating a bone mineral concentration in the trabecular bone from said intensity of backscattered X-rays.

23. The apparatus according to claim 22 wherein said thickness measurement means is an ultrasound source and detector mounted on said support frame, said ultrasound source and detector adapted to produce an ultrasound signal wherein said detector detects an ultrasound signal reflected from said trabecular bone, and wherein said soft tissue thickness is determined from a transit time for said ultrasound signal through said soft tissue and back from said trabecular bone.

24. The apparatus according to claim 22 including a heavy-metal source holder, said X-ray source being located in said source holder, said source holder being positioned with respect to said detector so that said source holder and detector have a common axis of symmetry and a collimated X-ray beam emerges from a front end of said source holder away from said detector.

25. The apparatus according to claim 24 wherein said support frame includes at least a support for supporting a person's foot containing a calcaneus, the source holder being mounted on said frame so that when a person's foot is immobilized on said foot support the X-ray source is located behind a person's heel so that the X-rays are directed toward the calcaneus along an axis of a person's foot substantially parallel to the sole of the foot.

26. The apparatus according to claim 22, wherein said X-ray source is a radioactive ¹⁰⁹Cd source.

27. The apparatus according to claim 24 wherein the detector is a cylindrically symmetric detector having a cylindrical axis, and wherein the heavy-metal source holder is a cylindrically symmetric source holder mounted along the cylindrical axis on a front portion of said detector, and wherein said detector is a NaI(TI) scintillation counter and photo multiplier combination.

28. The apparatus according to claim 22 including positioning means for positioning said source holder and detector with respect to said anatomical part.
